(19) United States
(12) Patent Application Publication
(10) Pub. No.: US 2025/0299500 A1
(43) Pub. Date: Sep. 25, 2025

(54) VEHICLE GUIDANCE METHOD AND SYSTEM BASED ON VISUAL SEMANTIC VECTOR, AND DEVICE AND MEDIUM

(71) Applicant: Chongqing Changan Automobile Co Ltd, Chongqing (CN)

(72) Inventors: Yi LUO, Chongqing (CN); Yifei KANG, Chongqing (CN); Zhiwei YAO, Chongqing (CN); Xiangjun PENG, Chongqing (CN)

(73) Assignee: Chongqing Changan Automobile Co Ltd, Chongqing (CN)

(21) Appl. No.: 18/862,152

(22) PCT Filed: Dec. 22, 2023
(86) PCT No.: PCT/CN2023/141246

§ 371 Date: Oct. 31, 2024

(30) Foreign Application Priority Data
Oct. 24, 2022 (CN) CN 202211305618.X

(51) Int. Cl. G06V 20/56; B60K 35/26; G06T 7/80; G06V 10/28; G06V 10/46; G06V 10/764; G06V 10/77; G06V 10/82; G06V 20/70

(52) U.S. Cl. CPC G06V 20/588; B60K 35/265; G06T 7/80; G06V 10/28; G06V 10/46; G06V 10/765; G06V 10/77; G06V 10/82; G06V 20/70

(57) ABSTRACT

A visual semantic vector-based vehicle guidance method and system, a device, and a medium are provided. The method includes: acquiring a road image, and classifying pixel points in the road image to obtain pixel point categories; performing point set partitioning according to pixel point positions and categories to obtain a plurality of pixel point sets, each pixel point set consisting of the pixel points with continuous positions and the same category; projecting the pixel points in each pixel point set to a ground coordinate system to obtain three-dimensional coordinate values of the pixel points in each pixel point set; determining a semantic coordinate and a direction of a corresponding pixel point set as a semantic vector of the pixel point set according to the three-dimensional coordinate value of each pixel point; and road surface marking positioning is performed according to the semantic vector to guide a vehicle to travel. Therefore, the robustness of the semantic vector can be enhanced and reliable data support can be provided for subsequent vehicle positioning.

### FIELD OF THE INVENTION

The present application relates to the field of intelligent driving, and in particular, to a visual semantic vector-based vehicle guidance method and system, a device, and a medium.

### BACKGROUND OF THE INVENTION

The development of a positioning function for an intelligent driving vehicle is a complex system project. For scenarios such as an expressway, a ramp, and a tunnel, visual information of a camera carried by an own vehicle and high-precision maps are generally used as positioning inputs, and a fusion positioning solution is adopted.

However, a feature point method is used in existing solutions. A position of the own vehicle is estimated by using the same feature points in continuous pictures. The feature points are easily affected by illumination variations, which results in a great error. A method for generating dense semantic point clouds based on semantic segmentation needs to consume a large amount of storage resources, and storing too much invalid information will affect the processing efficiency of a backend.

### SUMMARY OF THE INVENTION

In view of problems in the related art above, the present application provides a visual semantic vector-based vehicle guidance method and system, a device, and a medium, which mainly solves the problems of poor accuracy, too complex processing process, and difficulty in meeting actual application needs in existing methods.

In order to achieve the above-mentioned purpose, the present application adopts the following technical solutions.

The present application provides a visual semantic vector-based vehicle guidance method, including:
acquiring a road image, and classifying pixel points in the road image to obtain pixel point categories;
performing point set partitioning according to pixel point positions and categories to obtain a plurality of pixel point sets, each pixel point set consisting of the pixel points with continuous positions and the same category;
projecting the pixel points in each pixel point set to a ground coordinate system to obtain three-dimensional coordinate values of the pixel points in each pixel point set;
determining a semantic coordinate and a direction of a corresponding pixel point set as a semantic vector of the pixel point set according to the three-dimensional coordinate value of each pixel point; and
performing road surface marking positioning according to the semantic vector to guide a vehicle to travel.

In an embodiment of the present application, the classifying pixel points in the road image includes:
classifying the road image through a pre-trained neural network to obtain a pixel point category of each pixel point in the road image;
generating category code of each pixel point category according to a quantity of the pixel point categories; and
marking the road image according to the category code to obtain a gray-scale image of the road image as a semantic image, and performing point set portioning according to the semantic image.

In an embodiment of the present application, the performing point set partitioning according to pixel point positions and categories to obtain a plurality of pixel point sets includes:
acquiring all pixel points with the same category and the positions of the pixel points to form an initial set; and
selecting at least one pixel point from the initial set as an initial point, placing pixel points adjacent to the initial point into the same subset, and continuing to perform adjacent pixel point retrieving by taking the pixel points in the subset as basis points to obtain a plurality of subsets, each subset serving as a pixel point set.

In an embodiment of the present application, after the performing point set partitioning according to pixel point positions and categories to obtain a plurality of pixel point sets, the method further includes:
acquiring a centroid of each pixel point set, and calculating a distance between every two centroids; and
merging corresponding pixel point sets in a case that the distance between the two centroids is less than a preset distance threshold.

In an embodiment of the present application, the projecting the pixel points in each pixel point set to a ground coordinate system to obtain three-dimensional coordinate values of the pixel points in each pixel point set includes:
acquiring an intrinsic matrix and an extrinsic matrix of an image collection device for shooting the road image;
mapping the position of each pixel point in the pixel point set to a coordinate system of the image collection device according to the intrinsic matrix, and allocating a preset depth value for each pixel point to obtain a pixel point coordinate value in the coordinate system of the image collection device; and
projecting coordinate values of the pixel points in the coordinate system of the image collection device to the ground coordinate system according to the extrinsic matrix to obtain the three-dimensional coordinate value of each pixel point in the pixel point set.

In an embodiment of the present application, the determining a semantic coordinate and a direction of a corresponding pixel point set as a semantic vector of the pixel point set according to the three-dimensional coordinate value of each pixel point includes:
determining a centroid of the pixel point set according to the three-dimensional coordinate values of the pixel points in the pixel point set;
determining a covariance matrix of the pixel point set according to an offset between each pixel point and the centroid in the pixel point set;
performing Principal Component Analysis (PCA) on the covariance matrix to obtain a plurality of feature vectors; and
determining the direction of the pixel point set according to the feature vector with a maximum feature value, and determining the semantic vector of the pixel point set in combination with the direction of the pixel point set by taking a coordinate of the centroid as a semantic coordinate.

In an embodiment of the present application, after the performing PCA on the covariance matrix to obtain a plurality of feature vectors, the method further includes:
ranking feature values corresponding to all feature vectors from large to small, and comparing the top two feature values; and
eliminating a corresponding pixel point set in a case that a difference between the top two feature values is less than a preset difference threshold.

In an embodiment of the present application, after the determining the direction of the pixel point set according to the feature vector with a maximum feature value, the method further includes:
determining contour line information of the corresponding pixel point set according to the position of each pixel point in each pixel point set; and
comparing the contour line information with the direction of the pixel point set, and eliminating the corresponding pixel point set in a case that there is no contour line information parallel to the direction of the pixel point set.

In an embodiment of the present application, after the performing road surface marking positioning according to the semantic vector, the method includes:
generating a voice call instruction according to the direction of the semantic vector; and
outputting corresponding voice information from a preset voice library in response to the voice call instruction to guide the vehicle to travel.

The present application further provides a visual semantic vector-based vehicle guidance system, including:
a classification module, configured to acquire a road image, and classify pixel points in the road image to obtain pixel point categories;
a set partitioning module, configured to perform point set partitioning according to pixel point positions and categories to obtain a plurality of pixel point sets, each pixel point set consisting of the pixel points with continuous positions and the same category;
a coordinate transformation module, configured to project the pixel points in each pixel point set to a ground coordinate system to obtain three-dimensional coordinate values of the pixel points in each pixel point set;
a vectorization module, configured to determine a semantic coordinate and a direction of a corresponding pixel point set as a semantic vector of the pixel point set according to the three-dimensional coordinate value of each pixel point; and
a guidance module, configured to perform road surface marking positioning according to the semantic vector to guide a vehicle to travel.

The present application further provides a computer device, including a memory, a processor, and a computer program stored in the memory and capable of running on the processor. The processor implements steps of the visual semantic vector-based vehicle guidance method when executing the computer program.

The present application further provides a computer-readable storage medium, having a computer program stored thereon. The computer program implements steps of the visual semantic vector-based vehicle guidance method when executed by a processor.

As described above, the visual semantic vector-based vehicle guidance method and system, the device, and the medium of the present application have the following beneficial effects.

In the present application, a road image is acquired, and pixel points in the road image are classified to obtain pixel point categories; point set partitioning is performed according to pixel point positions and categories to obtain a plurality of pixel point sets, and each pixel point set consists of the pixel points with continuous positions and the same category; the pixel points in each pixel point set are projected to a ground coordinate system to obtain three-dimensional coordinate values of the pixel points in each pixel point set; a semantic coordinate and a direction of the corresponding pixel point set are determined as a semantic vector of the pixel point set according to the three-dimensional coordinate value of each pixel point; and a road surface marking is positioned according to the semantic vector to guide a vehicle to travel. According to the present application, the semantic vector in the road image is extracted on the basis of pixel level classification, which provides reliable data support for subsequent vehicle guidance and positioning, is convenient and quick to operate, and can avoid a large amount of unnecessary data storage. The semantic vector of the present application has higher robustness to illumination variation, and can meet the application needs of different actual road scenarios.

### BRIEF DESCRIPTION OF THE DRAWINGS

FIG. 1 is a schematic diagram of an application scenario for a visual semantic vector-based vehicle guidance system in an embodiment of the present application.

FIG. 2 is a schematic structural diagram of a terminal provided by embodiments of the present application.

FIG. 3 is a schematic flowchart of a visual semantic vector-based vehicle guidance method in an embodiment of the present application.

FIG. 4 is a schematic flowchart of semantic vectorization in an embodiment of the present application.

FIG. 5 is a module diagram of a visual semantic vector-based vehicle guidance system in an embodiment of the present application.

FIG. 6 is a schematic structural diagram of a device in an embodiment of the present application.

### DETAILED DESCRIPTION OF THE EMBODIMENTS

Implementations of the present application are described below through particular and specific examples. Other advantages and effects of the present application can be easily understood by those skilled in the art from the content disclosed in the present specification. The present application can also be implemented or applied by other additional different specific implementations. Various modifications or changes can also be made on various details in the present specification on the basis of different views and applications without departing from the spirit of the present application. It is to be noted that the following embodiments and features in the embodiments may be combined without a conflict.

It is to be noted that the diagrams provided by the following embodiments only illustrate a basic concept of the present application in a schematic way, so only the components related to the present application are shown in the diagrams instead of being drawn according to the number, shape, and size of the components in the actual implementation. The type, quantity, and scale of various components in the actual implementation can be changed at will, and the layout type of the components may be more complex.

In an embodiment, one or more image sensing apparatuses may be mounted on a vehicle body. The image sensing apparatus may include devices such as a camera. Exemplarily, one or more cameras may be installed in a forward direction or on a side of the vehicle to collect a road image in the forward direction or on the side in a vehicle traveling process. The road image is transmitted to a visual processing chip at a vehicle end or a server end through a network. A neural network model for processing an expressway scenario may be integrated on the visual processing chip. The neural network model converts a three-channel Red-Green-Blue (RGB) image into a single-channel semantic image to extract semantic vectors, for example, extracting the semantic vectors such as ground arrows, lane lines, and sidewalks, for vehicle end application navigation and assisted safe driving. An application scenario of a specific semantic vector may be adapted according to actual needs. No limits are made here.

Please refer to FIG. 1, which is a schematic diagram of an application scenario for a visual semantic vector-based vehicle guidance system in an embodiment of the present application. An image collection apparatus is generally installed on a vehicle body, or an image processing unit may be configured to pre-process an image acquired by the image collection apparatus, for example, converting a three-channel RGB image into a single-channel semantic image, performing pixel level classification on the semantic image, and extracting a semantic vector on the basis of the pixel level classification. Specific image pre-processing may be set according to actual application needs. No limits are made here. The image processing unit may be installed at a corresponding position of the vehicle body close to the image collection apparatus, which avoids data loss or data delay caused by long-distance data transmission. The image processing unit may also be arranged at a corresponding position of a server 200. The image collected by the vehicle end only needs to be uploaded to a server end, and the server end completes image processing to extract semantic vector information. A communication connection may be established between the image collection apparatus and the image processing unit through a mobile network to complete sensing data upload. A pre-trained neural network model and an algorithm model required for semantic vector extraction may be integrated in the image processing unit to complete the previously described semantic vector extraction process of the present application according to the integrated models. A specific pre-training process of the model may be performed on the server 200. If semantic vector processing is completed in the server 200, the server 200 may transmit the obtained semantic vector to a vehicle end, so that the vehicle end performs navigation or vehicle positioning according to the semantic vector.

In an embodiment, the server 200 may be an independent physical server, may also be a server cluster or a distributed system composed of a plurality of physical servers, or may also be a cloud server providing basic cloud computing services, such as a cloud service, a cloud database, cloud computing, a cloud function, cloud storage, a network service, cloud communication, a middleware service, a domain name service, a Content Delivery Network (CDN), big data, and an artificial intelligence platform.

in an embodiment, sample data set construction and corresponding model training may also be performed at the vehicle end. The vehicle end may be a vehicle terminal. After the image processing unit receives a real-time road image collected by a sensing collection apparatus, the real-time image is pre-processed and is displayed in real time through a vehicle display terminal, so that a passenger in a vehicle marks a road surface mark on the basis of the displayed road image to obtain a training sample corresponding to a sample image for training the neural network model. In another embodiment, a terminal may be a smart phone, a tablet computer, a notebook computer, a desktop computer, a smart speaker, a smart watch, a smart voice interaction device, a smart appliance, a vehicle terminal, and the like. No limits are made here.

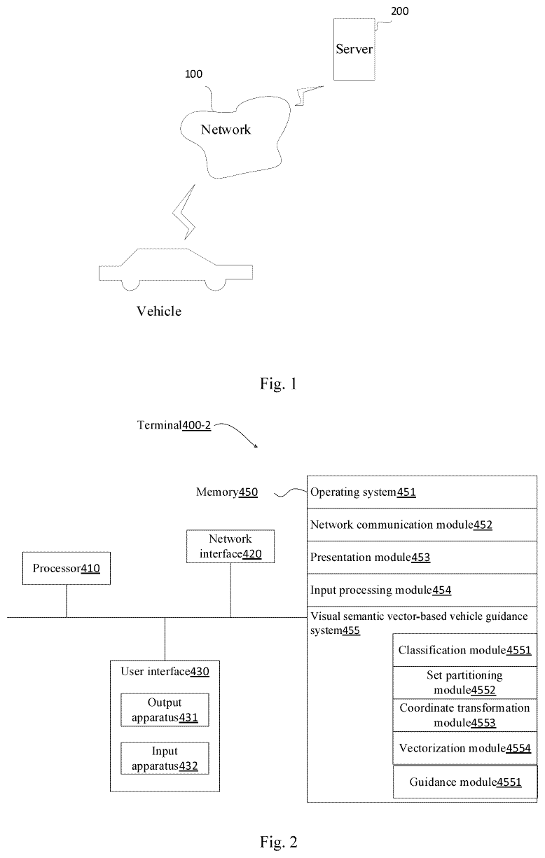

Refer to FIG. 2, which is a schematic structural diagram of a terminal 400 provided by an embodiment of the present application. The terminal 400 shown in FIG. 2 includes: at least one processor 410, a memory 450, and at least one network interface 420, and a user interface 430. Various components in the terminal 400 are coupled together by using a bus system 440. It may be understood that the bus system 440 is configured to implement connection and communication among these components. In addition to a data bus, the bus system 440 further includes a power bus, a control bus, and a state signal bus. However, for clarity of description, various buses are marked as the bus system 440 in FIG. 2.

The processor 410 may be an integrated circuit chip having a signal processing capability, for example, a general processor, a Digital Signal Processor (DSP), or other programmable logic devices, discrete gates or transistor logic devices, or discrete hardware components, or the like. The general processor may be a microprocessor, any conventional processor, or the like.

The user interface 430 includes one or more output apparatuses 431 that can present media content, which includes one or more speakers and/or more visual display screens. The user interface 430 further includes one or more input apparatuses 432, which includes a user interface component that facilitates user input, for example, a keyboard, a mouse, a microphone, a touch display screen, a camera, and other input buttons and controls.

The memory 450 may be removable, non-removable, or a combination thereof. An exemplary hardware device includes a solid state memory, a hard disk drive, an optical disk drive, and the like. The memory 250 optionally includes one or more storage devices that are located physically away from the processor 410.

The memory 450 includes a volatile memory or a non-volatile memory, or may include both a volatile memory and a non-volatile memory. The non-volatile memory may be a Read Only Memory (ROM), and the volatile memory may be a Random Access Memory (RAM). The memory 450 described in the embodiment of the present application aims to include any other suitable type of memory.

In some embodiments, the memory 450 can store data to support various operations. Examples of the data include a program, a module, a data structure, or a subset or a superset thereof, which are exemplarily described below.

An operating system 451 includes system programs for processing various basic system services and performing hardware related tasks, for example, a frame layer, a core library layer, and a drive layer, and is configured to implement various basic services and process hardware-based tasks.

A network communication module 452 is configured to reach other computing devices through one or more (wired or wireless) network interfaces 420. An exemplary network interface 420 includes: Bluetooth, Wireless Fidelity (WiFi), and a Universal Serial Bus (USB), and the like.

A presentation module 453 is configured to be capable of presenting information through one or more output apparatuses 431 (for example, a display screen and a loudspeaker) associated with the user interface 430 (for example, a user interface configured to operate a peripheral device and display content and information).

An input processing module 454 is configured to detect one or more user inputs or interactions from one or more input apparatuses 432 and translate the detected input or interaction.

In some embodiments, the apparatus provided by an embodiment of the present application may be implemented by software. FIG. 2 shows a visual semantic vector-based vehicle guidance system 455 stored in the memory 450, which may be software in forms of programs and plug-ins, and includes the following software modules: a classification module 4551, a set partitioning module 4552, a coordinate transformation module 4553, a vectorization module 4554, and a guidance module 4555. These modules are logical, so they can be randomly combined or further divided according to the realized functions.

Functions of various modules are described hereinafter.

In some other embodiments, the system provided by an embodiment of the present application may be implemented by hardware. As an example, the system provided by the embodiment of the present application may be a processor in the form of a hardware decoding processor which is programmed to execute the visual semantic vector-based vehicle guidance method provided by the embodiment of this application. For example, the processor in the form of the hardware decoding processor may use one or more Application Specific Integrated Circuits (ASICs), Digital Signal Processors (DSPs), Programmable Logic Devices (PLDs), Complex Programmable Logic Devices (CPLDs), Field Programmable Gate Arrays (FPGAs) or other electronic elements.

In some embodiments, the terminal or server may implement the visual semantic vector-based vehicle guidance method provided by the embodiment of the present application by running a computer program. For example, the computer program may be a native program or a software module in an operating system, may be a native Application (APP), that is, a program that can only run by installing in the operating system, for example, a social APP or a message sharing APP, or may be an applet, that is, a program that can run by simply downloading to a browser environment, or may be an applet or a web client program that can be embedded into any APP. In conclusion, the above computer program may be an application, a module, or a plug-in in any form.

The visual semantic vector-based vehicle guidance method provided by the embodiment of the present application will be described below in combination with exemplary applications and implementations of a device provided by the embodiment of the present application.

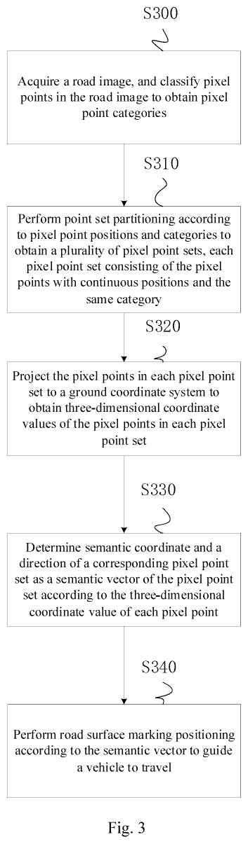

Please refer to FIG. 3 is a schematic flowchart of a visual semantic vector-based vehicle guidance method in an embodiment of the present application. The visual semantic vector-based vehicle guidance method of the embodiment of the present application includes the following steps.

At S300, a road image is acquired, and pixel points in the road image are classified to obtain pixel point categories.

In an embodiment, original camera visual perception data is first transmitted from a sensor to a visual processing chip. The chip is integrated with a neural network model trained for an expressway scenario in advance. A single-channel semantic picture is obtained for outputting after the neural network model performs convolution on the original three-channel RGB image layer by layer. Each pixel point of the semantic picture is classified into a specific category of elements, for example, ground arrows and sidewalks.

In an embodiment of the present application, the step that the pixel points in the road image are classified includes the following steps.

The road image is classified through a pre-trained neural network to obtain a pixel point category of each pixel point in the road image.

Category code of each pixel point category is generated according to a quantity of the pixel point categories.

The road image is marked according to the category code to obtain a gray-scale image of the road image as a semantic image, and point set portioning is performed according to the semantic image.

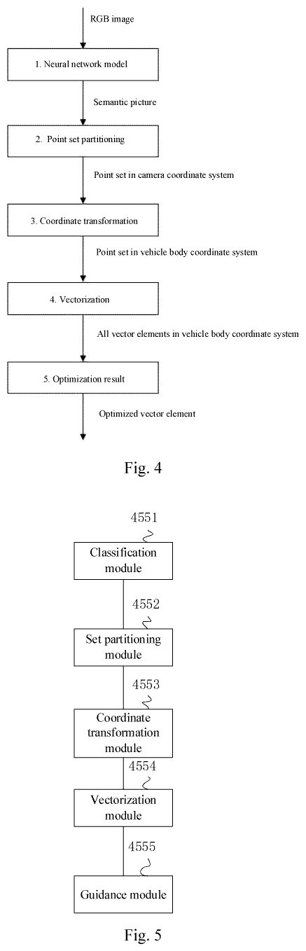

Please refer to FIG. 4, which is a schematic flowchart of semantic vectorization in an embodiment of the present application. After a camera transmits sensor image data into a visual processing chip, a single-channel semantic picture with a size of 480×256 is obtained for outputting after the neural network model on the chip processes an original three-channel RGB image.

A neural network may output 16 semantic categories, mainly including ground arrows, sidewalks, lane lines, backgrounds, roadblocks, light poles, signs, and the like, and the categories are respectively labeled with numbers from 0 to 16. In the output semantic picture, the gray-scale value range of each pixel point is 0 to 16, and a specific gray-scale value directly represents the semantic category of the pixel point.

At S310, point set partitioning is performed according to pixel point positions and categories to obtain a plurality of pixel point sets, each pixel point set consisting of the pixel points with continuous positions and the same category.

In an embodiment of the present application, the step that point set partitioning is performed according to pixel point positions and categories to obtain the plurality of pixel point sets includes:
all pixel points with the same category and the positions of the pixel points are acquired to form an initial set; and
at least one pixel point is selected from the initial set as an initial point, pixel points adjacent to the initial point are placed into the same subset, and adjacent pixel point retrieving is continued to be performed by taking the pixel points in the subset as basis points to obtain a plurality of subsets, each subset serving as a pixel point set.

After the semantic picture is acquired, the pixel points that belong to the same category are extracted, and all pixel points of the same category are partitioned in different sets according to whether the pixel points are continuous or not. For example, in the semantic picture, there are two ground arrows, all pixel points with the category of ground arrows are extracted first, then it may be determined that there are two disconnected pixel points in the picture that respectively belong to two ground arrows according to whether the pixel points are connected, and the pixel points at the two ground arrows are respectively extracted as two pixel point sets. In addition, pixel points of other categories may also be obtained in the same manner, for example, the sidewalks and the lane lines.

Specifically, after the semantic picture is obtained, the categories of all pixel points are distinguished and selected first according to the size of the picture, for example, the category of a ground arrow element is 8, then each pixel point of the semantic picture is traversed first. If a category value of a certain pixel point is equal to 8, the pixel point is added to the pixel point set of the ground arrows. After all pixel points that belong to the ground arrows (that is, the pixel points with the category value of 8) are selected, adjacent pixel points are recursively re-partitioned into a small point set to represent a single arrow.

Specific recursive algorithm logic is: each point in the point set is re-placed into a blank picture, then each pixel of the picture is traversed. From a first pixel point, if the category of the pixel point is 8, a next pixel point is searched in sequence, and a new sub-point set is created until a pixel point with the category of 8 is found. The point a is stored in the sub-point set, then four points on the top, bottom, left, and right of the pixel point a are searched. If the category of a point b above the point a is also 8, then the point b is also added to the sub-point set, whether categories of four points on the top, bottom, left, and right of the pixel point b are also 8 is continued to be searched until the points on the top, bottom, left, and right of all found points have been added to the point set. Or, the categories are not 8, then all points that are connected to the first found point a and are of the category of 8 have been found and added to the sub-point set. The sub-point set may be considered as all relevant pixel points of a ground arrow.

Then, other remaining pixel points are continued to be traversed to find other relevant pixel point sets of the ground arrow.

Other categories of semantic elements such as the lane lines and the sidewalks may also be processed in the same manner to find corresponding pixel point sets.

In an embodiment, after the step that point set partitioning is performed according to the pixel point positions and categories to obtain the plurality of pixel point sets, the method includes:
a centroid of each pixel point set is acquired, and a distance between every two centroids is calculated; and
corresponding pixel point sets are merged in a case that the distance between the two centroids is less than a preset distance threshold.

Specifically, due to complex road surface conditions, there are often situations that the lane lines or arrows are partially obstructed by mud or debris. Therefore, after obtaining the pixel point set of the same category, whether two pixel point sets correspond to the same road surface arrow or the same lane line may be determined on the basis of the distance between the centroids of the pixel point sets. A specific distance threshold may be set according to actual needs. No limits are made here. The pixel point sets are merged. Boundary line fitting may be performed on the basis of boundary lines of the two merged pixel point sets, and an obstructed boundary line is filled to obtain a boundary line of the merged pixel point sets for subsequent boundary line comparison.

At S320, the pixel points in each pixel point set are projected to a ground coordinate system to obtain three-dimensional coordinate values of the pixel points in each pixel point set.

In an embodiment of the present application, the step that the pixel points in each pixel point set are projected to the ground coordinate system to obtain the three-dimensional coordinate values of the pixel points in each pixel point set includes:
an intrinsic matrix and an extrinsic matrix of an image collection device for shooting a road image are acquired;
the position of each pixel point in the pixel point set is mapped to a coordinate system of the image collection device according to the intrinsic matrix, and a preset depth value is allocated for each pixel point to obtain a pixel point coordinate value in the coordinate system of the image collection device; and
coordinate values of the pixel points in the coordinate system of the image collection device are mapped to the ground coordinate system according to the extrinsic matrix to obtain the three-dimensional coordinate value of each pixel point in the pixel point set.

Specifically, for the pixel point sets that are obtained in the previously described steps and belong to the same semantic category, all pixel point coordinates are two-dimensional coordinates on an image plane. A three-dimensional coordinate corresponding to each pixel point in the real world needs to be acquired according to an intrinsic matrix and an extrinsic matrix of a camera.

The intrinsic matrix of the camera is used for transforming a certain pixel coordinate in the image into a camera coordinate system taking an optical center of the camera as an origin of coordinates. After that, a certain point in the camera coordinate system is transformed into a three-dimensional coordinate in a vehicle body coordinate system by using an extrinsic matrix of the camera, that is, a transformation matrix from the camera coordinate system to the vehicle body coordinate system.

There is a piece of dimension information, that is, a piece of depth information, in a process of transforming a two-dimensional image coordinate into a three-dimensional world coordinate, which cannot be restored through calculation. Therefore, ground plane assumption is adopted, that is, points corresponding to the pixel points in all images in the real world are all positioned in a ground plane with a height of 0. In this manner, the pixel point sets that are obtained in the previous step and belong to the same semantic category are all transformed into the three-dimensional coordinate point sets in the vehicle body coordinate system.

In an embodiment, the pixel points corresponding to semantic elements that can be found are all two-dimensional coordinate points (u, v) on the image plane, where u is a coordinate value in a horizontal direction of an image rightwards, and v is a coordinate value in a vertical direction of the image downwards; cx and cy are respectively offsets from a center point of the image to an upper left corner of the image; and fx, fy is a distance from a camera imaging plane to a camera convex lens, that is, a focal distance. The camera coordinate system is a three-dimensional space coordinate system with the optical center of the camera as the origin of coordinates and a z-axis facing forward.

The intrinsic matrix of the camera is

$$K = [ \begin{matrix}fx & 0 & cx \\ 0 & fy & cy \\ 0 & 0 & 1\end{matrix} ] .$$

A pixel point (u, v) on the image plane may be transformed into a point (x, y, 1) in the camera coordinate system by using the intrinsic matrix. A value in a z-axis direction cannot be restored since an image point only has two-dimensional information, so z is set as 1 here.

Next, the extrinsic matrix of the camera is a transformation relationship from the camera coordinate system to the vehicle body coordinate system, including two parts, that is, rotation and translation. The three-dimensional coordinate point in the camera coordinate system may be transformed into the three-dimensional space coordinate point in the vehicle body coordinate system by using the extrinsic matrix.

The transformed three-dimensional space coordinate point is projected to the ground plane, and a three-dimensional space coordinate (x, y, 0) in the vehicle body coordinate system is finally obtained. After all pixel point sets obtained in the previous step are transformed once, the pixel points of all ground arrow elements are obtained.

A three-dimensional space coordinate point set in the vehicle body coordinate system may be considered as a coordinate point set of the ground arrows in the real world.

At S330, a semantic coordinate and a direction of a corresponding pixel point set are determined as a semantic vector of the pixel point set according to the three-dimensional coordinate value of each pixel point.

In an embodiment of the present application, the step that the semantic coordinate and the direction of the corresponding pixel point set are determined as the semantic vector of the pixel point set according to the three-dimensional coordinate value of each pixel point includes:
a centroid of the pixel point set is determined according to the three-dimensional coordinate values of the pixel points in the pixel point set;
a covariance matrix of the pixel point set is determined according to an offset between each pixel point and the centroid in the pixel point set;
PCA is performed on the covariance matrix to obtain a plurality of feature vectors; and
the direction of the pixel point set is determined according to the feature vector with a maximum feature value, and the semantic vector of the pixel point set is determined in combination with the direction of the pixel point set by taking a coordinate of the centroid as a semantic coordinate.

In an embodiment, the centroid of the point set is solved first according to the three-dimensional space coordinate point set in the vehicle body coordinate system,

$$p = ( \overline{x} , \overline{y} ) = ( \frac{{\sum }_{i = 1}^{n} {x}_{i}}{n} , \frac{{\sum }_{i = 1}^{n} {y}_{i}}{n} ) ,$$

and then, a covariance P of the point set is solved according to the distance between the centroid and each point. The PCA is performed on the covariance to solve three feature values λ₁, λ₂, λ₃ (λ₁>λ₂>λ₃) of the covariance matrix and three feature vectors v1, v2, and v3 corresponding thereto. The feature vector v1 corresponding to the maximum feature value λ₁ is corresponding to a main direction of the point set, for example, for a point set corresponding to the ground arrow, the direction of the feature vector is an actual orientation direction of the arrow. Finally, the centroid p of the point set and a direction vector v1 form vectorized coordinate information of the semantic element.

For the three-dimensional point set that has been transformed into the vehicle body coordinate system and belong to the same semantic category, an average value of all points, that is, the centroid of the point set, is solved first. Then, a variance of the point set in three directions of x, y, and z and a correlated covariance is obtained according to a difference between the centroid and each point. The PCA is performed on the covariance to obtain a feature vector corresponding to a maximum feature value, that is, a main direction of the point set, for example, an orientation direction of an arrow, a major axis direction of a lane line, and a major axis direction of a sidewalk.

Finally, the calculated centroid of the point set is taken as a coordinate of the semantic element, the main direction of the point set is taken as a direction of the semantic element, that is, vectorization of the semantic element is completed.

Due to misidentification caused by possible noise in an image during shooting, incomplete shooting of ground elements, or incorrect recognition types of a neural network model, additional conditions are also needed to further eliminate some vectorized elements with poor effects.

In an embodiment of the present application, after the step that the PCA is performed on the covariance matrix to obtain the plurality of feature vectors, the method further includes:
feature values corresponding to all feature vectors are ranked from large to small, and the top two feature values are compared; and
a corresponding pixel point set is eliminated in a case that a difference between the top two feature values is less than a preset difference threshold.

Specifically, for the semantic elements such as the ground arrows, the sidewalks, and the lane lines, since the difference between major axes and minor axes of these elements is great, it may be determined that the semantic elements cannot be used and need to be eliminated if the difference between the ratio of a largest feature value and the ratio of a second largest feature value obtained from the PCA is not great. According to the three feature values solved in the previous step, the two larger feature values λ₁, λ₂ are compared. If the difference between the two feature values is not great, it is determined that the point set does not belong to the semantic elements with great difference between the major axes and the minor axes, such as the ground arrows, the sidewalks, and the lane lines.

In an embodiment of the present application, after the direction of the pixel point set is determined according to the feature vector with the maximum feature value, the method further includes:
contour line information of the corresponding pixel point set is determined according to the position of each pixel point in each pixel point set; and
the contour line information is compared with the direction of the pixel point set, and the corresponding pixel point set is eliminated in a case that there is no contour line information parallel to the direction of the pixel point set.

Specially, for the semantic elements such as the ground arrows, the sidewalks, and the lane lines, these elements include significant linear edge features. Therefore, contour lines of the semantic elements may be extracted by using contour extraction. If there is no contour line parallel to the main direction of the element, it may be determined that the semantic element cannot be used and needs to be eliminated. Through the determination based on these two conditions, misidentification, partial identification, and the like of most semantic elements can be eliminated. A pixel point of a corresponding ground element in an original three-channel RGB image is found by using a position of an obtained semantic pixel point set. The contour line information therein is extracted. After the contour line is transformed to the vehicle body coordinate system, it is compared to determine whether there is a certain contour line parallel to a direction vector of the point set. If there is no contour line parallel to the direction vector of the point set, it is determined that the ground element does not belong to the semantic elements with significant linear contours, such as the ground arrows, the sidewalks, and the lane lines.

At S340, road surface marking positioning is performed according to the semantic vector to guide a vehicle to travel.

In an embodiment of the present application, after the step that the road surface marking positioning is performed according to the semantic vector, the method includes:
a voice call instruction is generated according to the direction of the semantic vector; and
corresponding voice information is outputted from a preset voice library in response to the voice call instruction to guide the vehicle to travel.

In an embodiment, after the semantic vector is obtained, if the semantic vector is a ground arrow, voice guidance information related to the road arrow in the preset voice library, for example, “turn right ahead” and “straight ahead” is called. Voice matching calling may be performed on the basis of the semantic vector. Specific voice guidance information may be set according to actual application needs. No limits are made here. The road surface marking positioning or vehicle body positioning may also be performed on the basis of the semantic vector to determine a distance or a spatial positional relationship between a vehicle and a road surface marking.

Based on the technical solutions above, the semantic element vector information used in the present application is more robust to illumination variations. The extracted semantic element information, such as the ground arrows and the sidewalks, can stably output the same results in variable scenarios such as day, night, and rainy days, which greatly expands the scope of use of intelligent driving technology. Highly concentrated vectorized information is extracted, which can effectively save storage space and shorten backend computing time.

Please refer to FIG. 5, which is a module diagram of a visual semantic vector-based vehicle guidance system in an embodiment of the present application. The system includes: a classification module 4551, configured to acquire a road image, and classify pixel points in the road image to obtain pixel point categories; a set partitioning module 4552, configured to perform point set partitioning according to pixel point positions and categories to obtain a plurality of pixel point sets, each pixel point set consisting of the pixel points with continuous positions and the same category; a coordinate transformation module 4553, configured to project the pixel points in each pixel point set to a ground coordinate system to obtain three-dimensional coordinate values of the pixel points in each pixel point set; a vectorization module 4554, configured to determine a semantic coordinate and a direction of a corresponding pixel point set as a semantic vector of the pixel point set according to the three-dimensional coordinate value of each pixel point; and a guidance module 4555, configured to perform road surface marking positioning according to the semantic vector to guide a vehicle to travel.

In an embodiment, the classification module 4551 is further configured to classify the road image through a pre-trained neural network to obtain a pixel point category of each pixel point in the road image, generate category code of each pixel point category according to a quantity of the pixel point categories, mark the road image according to the category code to obtain a gray-scale image of the road image as a semantic image, and perform point set portioning according to the semantic image.

In an embodiment, the set partitioning module 4552 is further configured to perform point set partitioning according to pixel point positions and categories to obtain the plurality of pixel point sets, which includes: acquiring all pixel points with the same category and the positions of the pixel points to form an initial set; and selecting at least one pixel point from the initial set as an initial point, placing pixel points adjacent to the initial point into the same subset, and continuing to perform adjacent pixel point retrieving by taking the pixel points in the subset as basis points to obtain a plurality of subsets, each subset serving as a pixel point set.

In an embodiment, the set partitioning module 4552, after being configured to perform point set partitioning according to the pixel point positions and categories to obtain the plurality of pixel point sets, is further configured to: acquire a centroid of each pixel point set, and calculate a distance between every two centroids; and merge corresponding pixel point sets in a case that the distance between the two centroids is less than a preset distance threshold.

In an embodiment, the coordinate transformation module 4553 is further configured to project the pixel points in each pixel point set to a ground coordinate system to obtain three-dimensional coordinate values of the pixel points in each pixel point set, which includes: acquiring an intrinsic matrix and an extrinsic matrix of an image collection device for shooting the road image; mapping the position of each pixel point in the pixel point set to a coordinate system of the image collection device according to the intrinsic matrix, and allocating a preset depth value for each pixel point to obtain a pixel point coordinate value in the coordinate system of the image collection device; and projecting coordinate values of the pixel points in the coordinate system of the image collection device to the ground coordinate system according to the extrinsic matrix to obtain the three-dimensional coordinate value of each pixel point in the pixel point set.

In an embodiment, the vectorization module 4554 is further configured to determine a semantic coordinate and a direction of a corresponding pixel point set as a semantic vector of the pixel point set according to the three-dimensional coordinate value of each pixel point, which includes: determining a centroid of the pixel point set according to the three-dimensional coordinate values of the pixel points in the pixel point set; determining a covariance matrix of the pixel point set according to an offset between each pixel point and the centroid in the pixel point set; performing PCA on the covariance matrix to obtain a plurality of feature vectors; and determining the direction of the pixel point set according to the feature vector with a maximum feature value, and determining the semantic vector of the pixel point set in combination with the direction of the pixel point set by taking a coordinate of the centroid as a semantic coordinate.

In an embodiment, the vectorization module 4554, after being configured to perform the PCA on the covariance matrix to obtain the plurality of feature vectors, is further configured to: rank feature values corresponding to all feature vectors from large to small, and compare the top two feature values; and eliminate a corresponding pixel point set in a case that a difference between the top two feature values is less than a preset difference threshold.

In an embodiment, the vectorization module 4554, after being configured to determine the direction of the pixel point set according to the feature vector with the maximum feature value, is further configured to: determine contour line information of the corresponding pixel point set according to the position of each pixel point in each pixel point set; and compare the contour line information with the direction of the pixel point set, and eliminate the corresponding pixel point set in a case that there is no contour line information parallel to the direction of the pixel point set.

In an embodiment, the guidance module 4555, after being configured to perform road surface marking positioning according to the semantic vector, is further configured to: generate a voice call instruction according to the direction of the semantic vector; and output corresponding voice information from a preset voice library in response to the voice call instruction to guide a vehicle to travel.

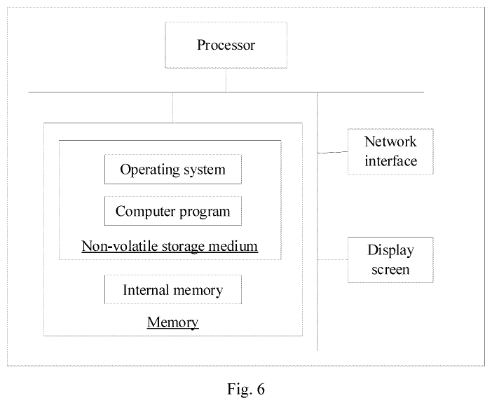

The above visual semantic vector-based vehicle guidance system may be implemented in a form of a computer program. The computer program may run on a computer device shown in FIG. 6. The computer device includes: a memory, a processor, and a computer program stored on the memory and capable of running on the processor.

Various modules in the above visual semantic vector-based vehicle guidance system may be completely or partially implemented by software, hardware, or combinations thereof. Each of the above modules may be embedded in or independent of a memory of a terminal, or may be stored in the memory of the terminal in a form of software, whereby the processor calls and performs operations corresponding to the above modules. The processor may be a Central Processing Unit (CPU), a microprocessor, a single chip computer, or the like.

FIG. 6 is a schematic diagram of an internal structure of a computer device in an embodiment of the present application. A computer device is provided, which includes: a memory, a processor, and a computer program stored on the memory and capable of running on the processor. The processor implements the following steps when executing the computer program: a road image is acquired, and pixel points in the road image are classified to obtain pixel point categories; point set partitioning is performed according to pixel point positions and categories to obtain a plurality of pixel point sets, and each pixel point set consists of the pixel points with continuous positions and the same category; the pixel points in each pixel point set are projected to a ground coordinate system to obtain three-dimensional coordinate values of the pixel points in each pixel point set; a semantic coordinate and a direction of the corresponding pixel point set are determined as a semantic vector of the pixel point set according to the three-dimensional coordinate value of each pixel point; and a road surface marking is positioned according to the semantic vector to guide a vehicle to travel.

In an embodiment, when the above processor executes, the implemented classification of the pixels in the road image includes: classifying the road image through a pre-trained neural network to obtain a pixel point category of each pixel point in the road image; generating category code of each pixel point category according to a quantity of the pixel point categories; and marking the road image according to the category code to obtain a gray-scale image of the road image as a semantic image, and performing point set portioning according to the semantic image.

In an embodiment, when the above processor executes, the implemented performing point set partitioning according to the pixel point positions and categories to obtain the plurality of pixel point sets includes: acquiring all pixel points with the same category and the positions of the pixel points to form an initial set; and selecting at least one pixel point from the initial set as an initial point, placing pixel points adjacent to the initial point into the same subset, and continuing to perform adjacent pixel point retrieving by taking the pixel points in the subset as basis points to obtain a plurality of subsets, each subset serving as a pixel point set.

In an embodiment, when the above processor executes, after the implemented performing point set partitioning according to the pixel point positions and categories to obtain the plurality of pixel point sets, the following steps are included: acquiring a centroid of each pixel point set, and calculating a distance between every two centroids; and merging corresponding pixel point sets in a case that the distance between the two centroids is less than a preset distance threshold.

In an embodiment, when the above processor executes, the implemented projecting the pixel points in each pixel point set to a ground coordinate system to obtain three-dimensional coordinate values of the pixel points in each pixel point set includes: acquiring an intrinsic matrix and an extrinsic matrix of an image collection device for shooting the road image; mapping the position of each pixel point in the pixel point set to a coordinate system of the image collection device according to the intrinsic matrix, and allocating a preset depth value for each pixel point to obtain a pixel point coordinate value in the coordinate system of the image collection device; and projecting coordinate values of the pixel points in the coordinate system of the image collection device to the ground coordinate system according to the extrinsic matrix to obtain the three-dimensional coordinate value of each pixel point in the pixel point set.

In an embodiment, when the processor executes, the implemented determining a semantic coordinate and a direction of a corresponding pixel point set as a semantic vector of the pixel point set according to the three-dimensional coordinate value of each pixel point includes: determining a centroid of the pixel point set according to the three-dimensional coordinate values of the pixel points in the pixel point set; determining a covariance matrix of the pixel point set according to an offset between each pixel point and the centroid in the pixel point set; performing PCA on the covariance matrix to obtain a plurality of feature vectors; and determining the direction of the pixel point set according to the feature vector with a maximum feature value, and determining the semantic vector of the pixel point set in combination with the direction of the pixel point set by taking a coordinate of the centroid as a semantic coordinate.

In an embodiment, when the above processor executes, after the implemented performing the PCA on the covariance matrix to obtain the plurality of feature vectors, the following steps are further included: ranking feature values corresponding to all feature vectors from large to small, and comparing the top two feature values; and eliminating a corresponding pixel point set in a case that a difference between the top two feature values is less than a preset difference threshold.

In an embodiment, when the above processor executes, after the implemented determining the direction of the pixel point set according to the feature vector with the maximum feature value, the following steps are further included: determining contour line information of the corresponding pixel point set according to the position of each pixel point in each pixel point set; and comparing the contour line information with the direction of the pixel point set, and eliminating the corresponding pixel point set in a case that there is no contour line information parallel to the direction of the pixel point set.

In an embodiment, when the above processor executes, after the implemented performing road surface marking positioning according to the semantic vector, the following steps are included: generating a voice call instruction according to the direction of the semantic vector; and outputting corresponding voice information from a preset voice library in response to the voice call instruction to guide a vehicle to travel.

In an embodiment, the above computer device may serve as a server, which includes, but is not limited to, an independent physical server, or a server cluster composed of a plurality of physical servers. The computer device may also be used as a terminal, which includes, but is not limited to, a mobile phone, a tablet computer, a personal digital assistant, a smart device, or the like. As shown in FIG. 6, the computer device includes a processor, a non-volatile storage medium, an internal memory, a display screen, and a network interface connected through a system bus.

The processor of the computer device is configured to provide computing and control capabilities to support the running of the whole computer device. The non-volatile storage medium of the computer device stores an operating system and a computer program. The computer program may be executed by the processor to implement the visual semantic vector-based vehicle guidance method provided by various embodiments above. The internal memory in the computer device provides a cache running environment for the operating system and the computer program in the non-volatile storage medium. A display interface may display data through a display screen. The display screen may be a touch screen, for example, a capacitive screen or an electronic screen, which may generate a corresponding instruction by receiving a click operation acting on a control displayed on the touch screen.

It can be understood by those skilled in the art that the structure of the computer device shown in FIG. 6 is only a block diagram of part structures related to the solution of the present application, and does not constitute a limitation on the computer device to which the solution of the present application is applied. A specific computer device may include more or fewer components than those shown in the figures, or combine some components, or have different component arrangements.

In an embodiment, a computer-readable storage medium is provided, which stores a computer program thereon. The computer program implements the following steps when executed by a processor: a road image is acquired, and pixel points in the road image are classified to obtain pixel point categories; point set partitioning is performed according to pixel point positions and categories to obtain a plurality of pixel point sets, and each pixel point set consists of the pixel points with continuous positions and the same category; the pixel points in each pixel point set are projected to a ground coordinate system to obtain three-dimensional coordinate values of the pixel points in each pixel point set; a semantic coordinate and a direction of the corresponding pixel point set are determined as a semantic vector of the pixel point set according to the three-dimensional coordinate value of each pixel point; and a road surface marking is positioned according to the semantic vector to guide a vehicle to travel.

In an embodiment, when the computer program is executed by the processor, the implemented classification of the pixels in the road image includes: classifying the road image through a pre-trained neural network to obtain a pixel point category of each pixel point in the road image; generating category code of each pixel point category according to a quantity of the pixel point categories; and marking the road image according to the category code to obtain a gray-scale image of the road image as a semantic image, and performing point set portioning according to the semantic image.

In an embodiment, when the computer program is executed by the processor, the implemented performing point set partitioning according to the pixel point positions and categories to obtain the plurality of pixel point sets includes: acquiring all pixel points with the same category and the positions of the pixel points to form an initial set; and selecting at least one pixel point from the initial set as an initial point, placing pixel points adjacent to the initial point into the same subset, and continuing to perform adjacent pixel point retrieving by taking the pixel points in the subset as basis points to obtain a plurality of subsets, each subset serving as a pixel point set.

In an embodiment, when the computer program is executed by the processor, after the implemented performing point set partitioning according to the pixel point positions and categories to obtain the plurality of pixel point sets, the following steps are implemented: acquiring a centroid of each pixel point set, and calculating a distance between every two centroids; and merging corresponding pixel point sets in a case that the distance between the two centroids is less than a preset distance threshold.

In an embodiment, when the computer program is executed by the processor, the implemented projecting the pixel points in each pixel point set to a ground coordinate system to obtain three-dimensional coordinate values of the pixel points in each pixel point set includes: acquiring an intrinsic matrix and an extrinsic matrix of an image collection device for shooting the road image; mapping the position of each pixel point in the pixel point set to a coordinate system of the image collection device according to the intrinsic matrix, and allocating a preset depth value for each pixel point to obtain a pixel point coordinate value in the coordinate system of the image collection device; and projecting coordinate values of the pixel points in the coordinate system of the image collection device to the ground coordinate system according to the extrinsic matrix to obtain the three-dimensional coordinate value of each pixel point in the pixel point set.

In an embodiment, when the computer program is executed by the processor, the implemented determining a semantic coordinate and a direction of a corresponding pixel point set as a semantic vector of the pixel point set according to the three-dimensional coordinate value of each pixel point includes: determining a centroid of the pixel point set according to the three-dimensional coordinate values of the pixel points in the pixel point set; determining a covariance matrix of the pixel point set according to an offset between each pixel point and the centroid in the pixel point set; performing PCA on the covariance matrix to obtain a plurality of feature vectors; and determining the direction of the pixel point set according to the feature vector with a maximum feature value, and determining the semantic vector of the pixel point set in combination with the direction of the pixel point set by taking a coordinate of the centroid as a semantic coordinate.

In an embodiment, when an instruction is executed by the processor, after the implemented performing the PCA on the covariance matrix to obtain the plurality of feature vectors, the following steps are further included: ranking feature values corresponding to all feature vectors from large to small, and comparing the top two feature values; and eliminating a corresponding pixel point set in a case that a difference between the top two feature values is less than a preset difference threshold.

In an embodiment, when the instruction is executed by the processor, after the implemented determining the direction of the pixel point set according to the feature vector with the maximum feature value, the following steps are further included: determining contour line information of the corresponding pixel point set according to the position of each pixel point in each pixel point set; and comparing the contour line information with the direction of the pixel point set, and eliminating the corresponding pixel point set in a case that there is no contour line information parallel to the direction of the pixel point set.

In an embodiment, when the instruction is executed by the processor, after the implemented performing road surface marking positioning according to the semantic vector, the following steps are included: generating a voice call instruction according to the direction of the semantic vector; and outputting corresponding voice information from a preset voice library in response to the voice call instruction to guide a vehicle to travel.

It can be understood by those of ordinary skill in the art that all or part processes in the methods of the above embodiments may be implemented by a computer program to instruct related hardware, and the program may be stored in a non-volatile computer-readable storage medium. When the program is executed, the processes of each of the above method embodiments may be included. The storage medium may be a magnetic disc, a compact disc, a ROM, or the like.

The above embodiments only exemplarily describe principle and effects of the present application, and are not intended to limit the present application. Any person skilled in the art may modify or change the above embodiments without departing from the spirit and scope of the present application. Therefore, all equivalent modifications or changes completed by those with ordinary knowledge in the technical field without departing from the spirit and technical ideas disclosed in the present application are still to be covered by the claims of the present application.

1. A visual semantic vector-based vehicle guidance method, comprising:
acquiring a road image, and classifying pixel points in the road image to obtain pixel point categories;
performing point set partitioning according to pixel point positions and categories to obtain a plurality of pixel point sets, each pixel point set consisting of the pixel points with continuous positions and the same category;
projecting the pixel points in each pixel point set to a ground coordinate system to obtain three-dimensional coordinate values of the pixel points in each pixel point set;
determining a semantic coordinate and a direction of a corresponding pixel point set as a semantic vector of the pixel point set according to the three-dimensional coordinate value of each pixel point; and
performing road surface marking positioning according to the semantic vector to guide a vehicle to travel.

2. The visual semantic vector-based vehicle guidance method according to claim 1, wherein the classifying pixel points in the road image comprises:
classifying the road image through a pre-trained neural network to obtain a pixel point category of each pixel point in the road image;
generating category code of each pixel point category according to a quantity of the pixel point categories; and
marking the road image according to the category code to obtain a gray-scale image of the road image as a semantic image, and performing point set portioning according to the semantic image.

3. The visual semantic vector-based vehicle guidance method according to claim 1 or 2, wherein the performing point set partitioning according to pixel point positions and categories to obtain a plurality of pixel point sets comprises:
acquiring all pixel points with the same category and the positions of the pixel points to form an initial set; and
selecting at least one pixel point from the initial set as an initial point, placing pixel points adjacent to the initial point into the same subset, and continuing to perform adjacent pixel point retrieving by taking the pixel points in the subset as basis points to obtain a plurality of subsets, each subset serving as a pixel point set.

4. The visual semantic vector-based vehicle guidance method according to claim 3, wherein after the performing point set partitioning according to pixel point positions and categories to obtain a plurality of pixel point sets, the method comprises:
acquiring a centroid of each pixel point set, and calculating a distance between every two centroids; and
merging corresponding pixel point sets in a case that the distance between the two centroids is less than a preset distance threshold.

5. The visual semantic vector-based vehicle guidance method according to claim 1, wherein the projecting the pixel points in each pixel point set to a ground coordinate system to obtain three-dimensional coordinate values of the pixel points in each pixel point set comprises:
acquiring an intrinsic matrix and an extrinsic matrix of an image collection device for shooting the road image;
mapping the position of each pixel point in the pixel point set to a coordinate system of the image collection device according to the intrinsic matrix, and allocating a preset depth value for each pixel point to obtain a pixel point coordinate value in the coordinate system of the image collection device; and
projecting coordinate values of the pixel points in the coordinate system of the image collection device to the ground coordinate system according to the extrinsic matrix to obtain the three-dimensional coordinate value of each pixel point in the pixel point set.

6. The visual semantic vector-based vehicle guidance method according to claim 1, wherein the determining a semantic coordinate and a direction of a corresponding pixel point set as a semantic vector of the pixel point set according to the three-dimensional coordinate value of each pixel point comprises:
determining a centroid of the pixel point set according to the three-dimensional coordinate values of the pixel points in the pixel point set;
determining a covariance matrix of the pixel point set according to an offset between each pixel point and the centroid in the pixel point set;
performing Principal Component Analysis (PCA) on the covariance matrix to obtain a plurality of feature vectors; and
determining the direction of the pixel point set according to the feature vector with a maximum feature value, and determining the semantic vector of the pixel point set in combination with the direction of the pixel point set by taking a coordinate of the centroid as a semantic coordinate.

7. The visual semantic vector-based vehicle guidance method according to claim 5, wherein after the performing PCA on the covariance matrix to obtain a plurality of feature vectors, the method further comprises:
ranking feature values corresponding to all feature vectors from large to small, and comparing the top two feature values; and
eliminating a corresponding pixel point set in a case that a difference between the top two feature values is less than a preset difference threshold.

8. The visual semantic vector-based vehicle guidance method according to claim 5, wherein after the determining the direction of the pixel point set according to the feature vector with a maximum feature value, the method further comprises:
determining contour line information of the corresponding pixel point set according to the position of each pixel point in each pixel point set; and
comparing the contour line information with the direction of the pixel point set, and eliminating the corresponding pixel point set in a case that there is no contour line information parallel to the direction of the pixel point set.

9. The visual semantic vector-based vehicle guidance method according to claim 1, wherein after the performing road surface marking positioning according to the semantic vector, the method further comprises:
generating a voice call instruction according to the direction of the semantic vector; and
outputting corresponding voice information from a preset voice library in response to the voice call instruction to guide the vehicle to travel.

10. A visual semantic vector-based vehicle guidance system, comprising:
a classification module, configured to acquire a road image, and classify pixel points in the road image to obtain pixel point categories;
a set partitioning module, configured to perform point set partitioning according to pixel point positions and categories to obtain a plurality of pixel point sets, each pixel point set consisting of the pixel points with continuous positions and the same category;
a coordinate transformation module, configured to project the pixel points in each pixel point set to a ground coordinate system to obtain three-dimensional coordinate values of the pixel points in each pixel point set;
a vectorization module, configured to determine a semantic coordinate and a direction of a corresponding pixel point set as a semantic vector of the pixel point set according to the three-dimensional coordinate value of each pixel point; and
a guidance module, configured to perform road surface marking positioning according to the semantic vector to guide a vehicle to travel.

11. A computer device, comprising a memory, a processor, and a computer program stored in the memory and capable of running on the processor, wherein the processor implements steps of the visual semantic vector-based vehicle guidance method according to any one of claims 1 to 9 when executing the computer program.

12. A computer-readable storage medium, having a computer program stored thereon, wherein the computer program implements steps of the visual semantic vector-based vehicle guidance method according to any one of claims 1 to 9 when executed by a processor.
